(19) United States
(12) Patent Application Publication
(10) Pub. No.: US 2024/0034060 A1
(43) Pub. Date: Feb. 1, 2024

(54) INKJET RECORDING DEVICE

(71) Applicant: Hitachi Industrial Equipment Systems Co., Ltd., Tokyo (JP)

(72) Inventors: Shoichiro KISANUKI, Tokyo (JP); Manabu KATO, Tokyo (JP); Koma SATO, Tokyo (JP); Taisuke SUGII, Tokyo (JP)

(73) Assignee: Hitachi Industrial Equipment Systems Co., Ltd., Tokyo (JP)

(21) Appl. No.: 18/276,138

(22) PCT Filed: Dec. 6, 2021
(86) PCT No.: PCT/JP2021/044649

§ 371 Date: Aug. 7, 2023

(30) Foreign Application Priority Data
Feb. 8, 2021 (JP) 2021-017888

(51) Int. Cl. B41J 2/09; B41J 2/085; B41J 2/185

(52) U.S. Cl. CPC B41J 2/09; B41J 2/085; B41J 2/185; B41J 2002/1853

(57) ABSTRACT

A novel inkjet recording device that allows occurrence of scattering to be suppressed without limiting the size of a printed character (font size) is provided. The novel inkjet recording device is so configured that a deflection positive electrode, a deflection negative electrode, or both the deflection positive electrode and the deflection negative electrode constituting a print head can be moved along a direction of ejection of ink droplets in correspondence with the size of a printed character.

### TECHNICAL FIELD

The present invention relates to an inkjet recording device and in particular to a continuous-injection charge-controlled inkjet recording device.

### BACKGROUND ART

An ordinary continuous-injection charge-controlled inkjet recording device is provided in the main body thereof with an ink container for reserving ink and ink in the ink container is supplied to a print head by an ink supply pump. The inkjet recording device is so configured as to implement the following operation: The ink supplied to the print head is continuously jetted out from an ink nozzle and is turned into ink droplets. Of the ink droplets, ink droplets to be used for printing are electrified and deflected and are caused to fly to a desired print position in a printed object to form a character or a symbol (hereafter, representatively referred to as character). Ink droplets not to be used for printing are not electrified or deflected and are collected through a gutter and returned to the ink container by an ink recovery pump. Hereafter, a printed character will be defined as a “printed character.”

A continuous-injection charge-controlled inkjet recording device jets several tens of thousands of ink droplets per second to print and is thus capable of high-speed printing. Meanwhile, ink droplets in flight are subjected to Coulomb force caused by electrification of the ink droplets and air drag corresponding to the diameter of the ink droplet and an ambient flow field. For this reason, when attention is paid to a plurality of ink droplets flying in proximity to one another, a phenomenon called “scattering” can occur.

Scattering is a phenomenon in which when ink droplets approach each other during flight, Coulomb force is produced due to the electrified amounts of the ink droplets and the directions of flight of the two ink droplets are varied. When scattering occurs, a spacing between two printed dots formed on a printed object is unnaturally increased and this can degrade the viewability of a printed character.

For this reason, with respect to this type of an inkjet recording device, for example, the inkjet recording device described in Japanese Unexamined Patent Application Publication No. 2002-264339 (Patent Literature 1), the following is proposed: The shapes of a deflection positive electrode and a deflection negative electrode constituting deflection electrodes are curved in accordance with the flight paths of ink droplets to enhance the efficiency of deflection of the ink droplets in flight. A duration during which the Coulomb force is exerted between flying droplets is thereby shortened to suppress the possibility of occurrence of scattering.

### CITATION LIST

### Patent Literature

### PTL 1: Japanese Unexamined Patent Application No. 2002-264339

### SUMMARY OF INVENTION

### Technical Problem

In this type of an inkjet recording device, a character large in font size and a character small in font size are frequently printed on a printed object with a single inkjet recording device.

In this case, a character large in font size is longer than a character small in font size in a distance between adhering ink droplets. That a distance between adhering ink droplets is long means that the ink droplets do not approach each other during flight. For this reason, scattering is less prone to occur.

However, a character small in font size is shorter than a character large in font size in a distance between adhering ink droplets. That a distance between adhering ink droplets is short means that the ink droplets approach each other during flight. For this reason, scattering is prone to occur. Aside from font size, a similar phenomenon can occur also when a spacing between adjoining printed dots forming a printed character is long and when the spacing is short.

To cope with this phenomenon, in Patent Literature 1, the shapes of a deflection positive electrode and a deflection negative electrode are curved in accordance with a flight path of ink droplets to achieve highly efficient deflection. However, since the degree of curvature of the electrodes cannot be adjusted, the following problem arises: An ink droplet whose flight path is not in accordance with a curvature cannot be printed and the size of a printed character is limited.

It is an object of the present invention to provide a novel inkjet recording device in which occurrence of scattering can be suppressed without being limited by a size of a printed character or a spacing between adjoining printed dots.

### Solution to Problem

The present invention is characterized in that the present invention is so configured that a position of production of an electrostatic field formed by a deflection electrode can be adjusted to a direction of jetting-out of ink liquid.

The present invention is further characterized in that the present invention is so configured that a deflection positive electrode or a deflection negative electrode or both a deflection positive electrode and a deflection negative electrode constituting a print head can be moved along a direction of jetting-out of ink droplets.

A direction of jetting-out of an ink droplet does not refer to a direction of deflection of an ink droplet but refers to a direction in which an ink droplet straightly travels.

### Advantageous Effects of Invention

According to the present invention, occurrence of scattering can be suppressed without being limited by a size of a printed character or a spacing between adjoining printed dots. Other configuration elements and effects than described above will be apparent from the following description of embodiments.

### BRIEF DESCRIPTION OF DRAWINGS

FIG. 1 is a schematic diagram explaining a method of printing with an inkjet recording device;

FIG. 2 is a block diagram explaining a principle of printing with an inkjet recording device;

FIG. 3 is an explanatory drawing explaining a print matrix forming a printed character;

FIG. 4 is an explanatory drawing explaining displacement of positions of adherence of ink droplets forming a printed character;

FIG. 5 is a block diagram illustrating a configuration of deflection electrodes taken when a printed character is large in size, explaining a configuration of deflection electrodes according to a first embodiment of the present invention;

FIG. 6 is a block diagram illustrating a configuration of deflection electrodes taken when a printed character is small in size, explaining a configuration of deflection electrodes according to a first embodiment of the present invention;

FIG. 7 is an explanatory drawing explaining a state of production of an electrostatic field formed by the deflection electrodes shown in FIG. 5 and FIG. 6;

FIG. 8 is a block diagram illustrating a configuration of deflection electrodes taken when a printed character is large in size, explaining a configuration of deflection electrodes according to a second embodiment of the present invention;

FIG. 9 is a block diagram illustrating a configuration of deflection electrodes taken when a printed character is small in size, explaining a configuration of deflection electrodes according to a second embodiment of the present invention;

FIG. 10 is an explanatory drawing explaining a state of production of an electrostatic field formed by the deflection electrodes shown in FIG. 8 and FIG. 9;

FIG. 11 is a block diagram illustrating a configuration of deflection electrodes taken when a printed character is large in size, explaining a configuration of deflection electrodes according to a third embodiment of the present invention;

FIG. 12 is a block diagram illustrating a configuration of deflection electrodes taken when a printed character is small in size, explaining a configuration of deflection electrodes according to a third embodiment of the present invention;

FIG. 13 is an explanatory drawing explaining a state of production of an electrostatic field formed by the deflection electrodes shown in FIG. 11 and FIG. 12.

### DESCRIPTION OF EMBODIMENTS

Hereafter, a detailed description will be given to embodiments of the present invention with reference to the figures. However, the present invention is not limited to the following embodiments and various examples of modification and application within the technical concept of the present invention are also included in the scope of the present invention.

### Example 1

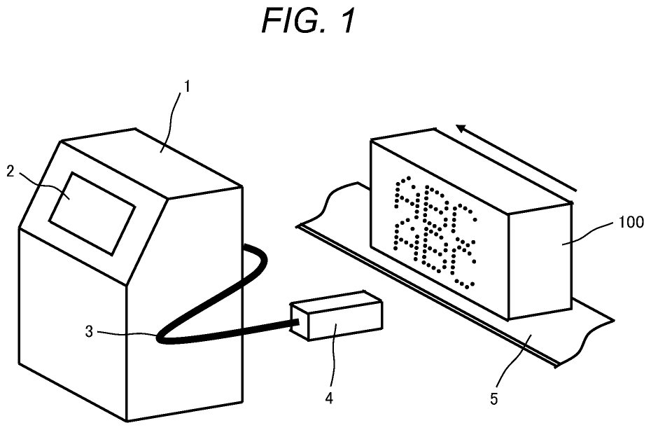

First, a description will be given to a configuration of a continuous-injection charge-controlled inkjet recording device to which the present invention is applied and a printing method therefor with reference to FIG. 1.

FIG. 1 shows an appearance and a configuration of the inkjet recording device and a state of use thereof. First, using a display 2 provided in the inkjet recording device main body 1, contents of print including font size are determined. The determined contents of print are printed onto a printed object 100 conveyed by such a conveyance means 5 as a belt conveyor by continuously ejecting ink droplets from a print head 4. The inkjet recording device main body 1 performs ink supply to the print head 4 and operation control via a cable 3.

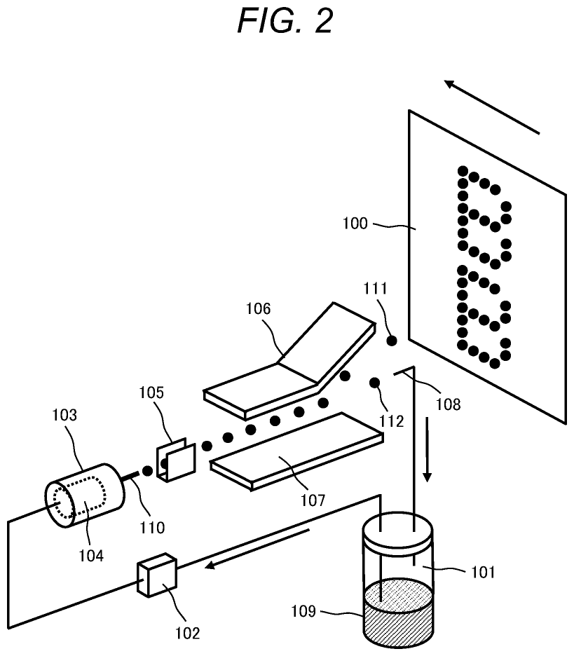

Subsequently, a description will be given to a principle of printing with a continuous-injection charge-controlled inkjet recording device to which the present invention is applied with reference to FIG. 2.

FIG. 2 schematically shows a principle of printing of the inkjet recording device. In FIG. 2, ink liquid 109 reserved in an ink container 101 is pressurized by an ink supply pump 102 and is supplied to an ink nozzle 103. By periodically applying voltage to a piezoelectric element 104 installed in the ink nozzle 103, the ink in the ink nozzle 103 is excited. The excited ink is ejected as an ink column 110 from the ink nozzle 103 and then turned into ink droplets. Ink to be used for printing is turned into ink droplets and is simultaneously electrified by an electrifying electrode 105.

An electrified ink droplet 111 is deflected by an electric field produced between a deflection positive electrode 106 and a deflection negative electrode 107 and then adheres to the printed object 100. Meanwhile, an ink droplet 112 not to be used for printing is not electrified; therefore, the non-electrified ink droplet 112 is not deflected and is recovered through a gutter 108. The recovered ink is returned to the ink container 101.

The inkjet recording device main body 1 in FIG. 1 houses the ink container 101 and ink supply pump 102 and the like, shown in FIG. 2. The print head 4 in FIG. 1 houses the ink nozzle 103, electrifying electrode 105, deflection positive electrode 106, deflection negative electrode 107, and gutter 108, and the like shown in FIG. 2.

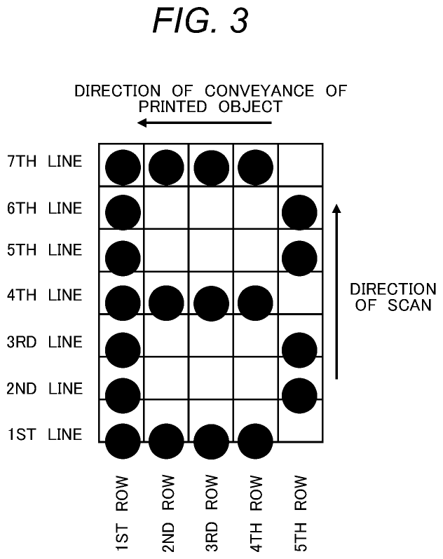

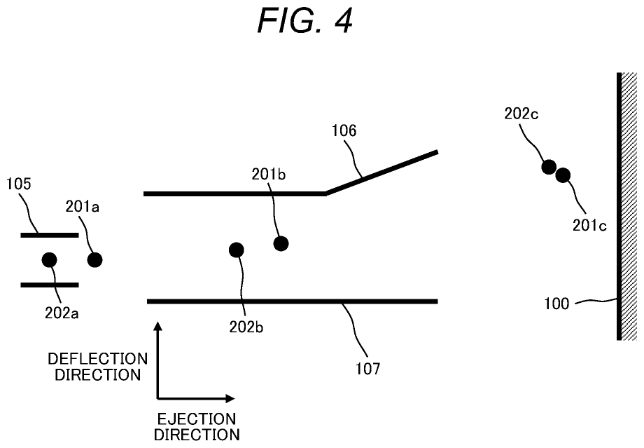

A brief description will be given to a problem that conventionally used to arise when a character is printed using the above-mentioned inkjet recording device with reference to FIG. 3 and FIG. 4.

FIG. 3 shows a print matrix used to print an alphabetical character of “B” as an example of a printed character. FIG. 4 shows a behavior of electrified ink droplets exhibited over the course of time to explain a reason why scattering occurs.

In an inkjet recording device, the contents of print are formed by scanning rows one by one in the vertical direction and continuously conveying a printed object while this is being done, as shown in FIG. 3. In a scan of one row, ink droplets are sequentially electrified so that printed dots (shown as black circles) are formed from the lowermost line toward the uppermost line. Meanwhile, when a printed dot is not present on the print matrix, an ink droplet is not electrified and is recovered.

At this time, ink droplets forming, for example, printed dots in the first line and second line in the first row are continuously electrified and are brought close to each other at the time of electrification. The ink droplets electrified in proximity to each other are brought closer to each other during flight; therefore, scattering occurs before adherence to the printed object. As a result, the positions of the printed dots in the first line and second line in the first row are displaced and a phenomenon of degraded print quality occurs.

When a character large in font size is printed, electrified amounts of the two ink droplets differ from each other and a difference in amount of deflection is increased. As a result, ink droplets in flight do not approach each other and thus scattering is less prone to occur. Meanwhile, when a character small in font size is printed, electrified amounts of two ink droplets approximate to each other and a difference in amount of deflection is reduced. As a result, the ink droplets in flight approach each other and thus scattering is prone to occur.

In the description in relation to FIG. 3, a printed character of an alphabetical character of “B” has been taken as an example but displacement of the positions of adherence of ink droplets caused by scattering is not limited to the printed character shown in FIG. 3. Even when print control or contents of print differ, the positions of adherence of ink droplets can be displaced by scattering. A more specific description will be given. When two or more ink droplets similar to each other in flight path are electrified at a close distance, for example, like adjoining ink droplets during printing, scattering can occur between those ink droplets.

A description will be given to a reason why two ink droplets similar to each other in flight path and electrified at a close distance further approach each other during flight. FIG. 4 schematically shows a positional relation between two ink droplets during a period from when the ink droplets are formed until when, after passage through deflection electrodes, the ink droplets adhere to a printed object.

The ink droplet 201a, ink droplet 201b, and ink droplet 201c going ahead shown in FIG. 4 are an identical ink droplet and these ink droplets respectively indicate their respective flight positions at a certain time. Similarly, the ink droplet 202a, ink droplet 202b, and ink droplet 202c going behind are also an identical ink droplet and indicate their respective flight positions at the above-mentioned certain time.

First, at a certain time (t1), electrified ink droplet 201a and ink droplet 202a are formed inside the electrifying electrode 105. At this time, the magnitude of air drag exerted on the ink droplet 201a and the ink droplet 202a are substantially common. This is because the other ink droplets are also periodically formed and ejected and ink droplets before deflection linearly fry.

At a certain time (t2) after the lapse of a predetermined time, thereafter, the ink droplet 201b and ink droplet 202b that went into between the deflection positive electrode 106 and the deflection negative electrode 107 are deflected by an electric field produced by the deflection electrodes. In cases where a flying ink droplet is not present ahead of the ink droplet 201b at this time, the magnitude of air drag exerted on the ink droplet 201b is not reduced by any other cause than deceleration.

Meanwhile, the ink droplet 201b flies ahead of the ink droplet 202b and forms an air current behind. When the flight path of the ink droplet 202b is similar to the flight path of the ink droplet 201b, the ink droplet 202b consequently flies in the air current formed by the ink droplet 201b and the magnitude of air drag is reduced. For this reason, the ink droplet 201b and the ink droplet 202b exhibit a behavior of the ink droplets gradually approaching each other during flight.

At a certain time (t3) after the lapse of a predetermined time, thereafter, the ink droplet 201c and the ink droplet 202c represent a positional relation taken by the ink droplets 201c, 202c that most closely approach each other and at this time, scattering due to Coulomb force occurs.

As mentioned above, two ink droplets similar to each other in flight path and electrified at a close distance approach each other during flight. However, when printed dots are continuously formed in a line direction or when flight paths are sufficiently different, even in case of two ink droplets electrified at a close distance, scattering is less prone to occur. An example of such a case is a case where a character to be printed is sufficiently large in a direction of deflection of ink droplets and electrified amounts given to the ink droplet 201a and the ink droplet 202b are sufficiently different (for example, a case where font size is large). In this case, the ink droplet 202 flies in deviation from an air current formed by the ink droplet 201; therefore, approaching of ink droplets in flight and scattering based on the approaching are less prone to occur.

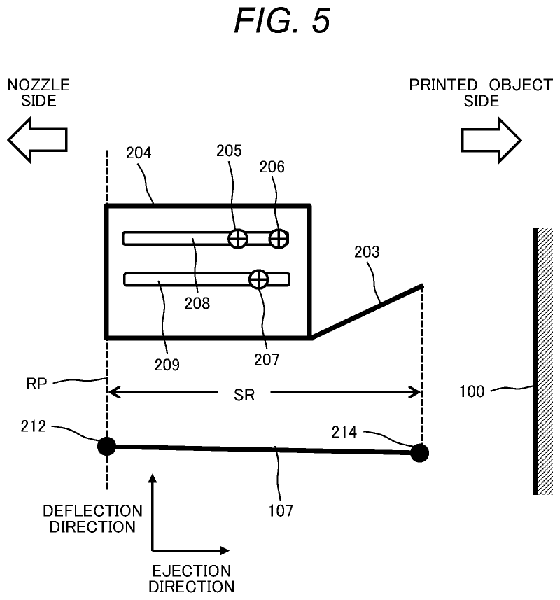

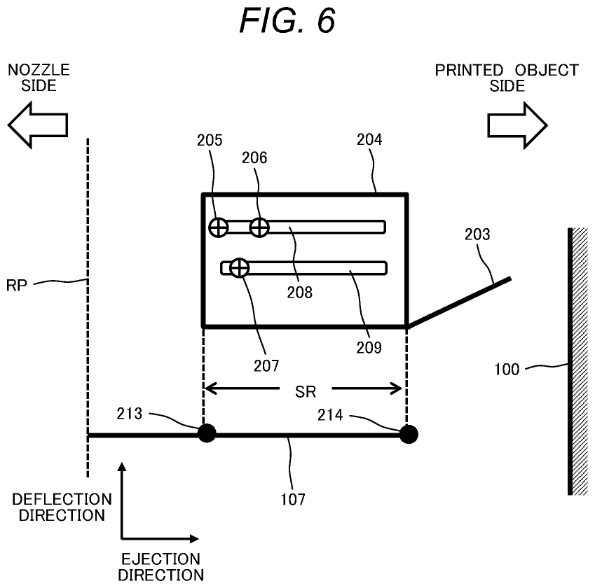

Based on such a background, a description will be given to a configuration of an inkjet recording device according to a first embodiment of the present invention with reference to FIG. 5 and FIG. 6. FIG. 5 and FIG. 6 illustrate the first embodiment is so configured that a deflection positive electrode is movable along a direction of jetting-out of ink droplets. FIG. 5 shows a position of the deflection positive electrode taken when font size is large and FIG. 6 shows a position of the deflection positive electrode taken when font size is small.

In FIG. 5, a position of the deflection negative electrode 107 is fixed and invariant but the deflection positive electrode 203 is movable in a direction of jetting-out of ink droplets. For this reason, the print head is movably equipped with a plate slide panel 204. The deflection positive electrode 203 is fixed at the lower end of this slide panel 204 and the slide panel 204 and the deflection positive electrode 203 are so configured as to be moved together.

The directions of movement of the slide panel 204 and the deflection positive electrode 203 are a direction of jetting-out of ink droplets. This direction of jetting-out of ink droplets is not a direction of deflection of ink droplets but is a direction in which ink droplets straightly travel.

A position adjustment groove 208 and a position adjustment groove 209 are formed in the slide panel 204 and a position adjustment screw 205, a position adjustment screw 206, and a position adjustment screw 207 are inserted into the position adjustment groove 208 and the position adjustment groove 209 and screwed into the inner wall of the print head. As a result, the slide panel 204 is fixed on the inner wall of the print head by moving the slide panel 204 and adjusting the position thereof relative to the print head and then tightening the position adjustment screw 205, position adjustment screw 206, and position adjustment screw 207.

As mentioned above, the slide panel 204 and the deflection positive electrode 203 can be moved in a direction of jetting-out of ink droplets through the position adjustment groove 208 and the position adjustment groove 209 by loosening the position adjustment screw 205, position adjustment screw 206, and position adjustment screw 207.

FIG. 5 illustrates the deflection negative electrode 107 and the deflection positive electrode 203 as are located in a reference position RP and in the drawing, the slide panel 204 is located in the leftmost position. When font size is large, printing can be performed in this state.

A deflection start point 212 that is a position of production of an electrostatic field is a position where a portion of overlapping between the deflection negative electrode 107 and the deflection positive electrode 203 starts on the ink nozzle 103 (Refer to FIG. 2) side. A deflection end point 214 that is a position of annihilation of an electrostatic field is a position where a portion of overlapping between the deflection negative electrode 107 and the deflection positive electrode 203 ends on the printed object 100 side. Therefore, the area between the deflection start point 212 and the deflection end point 214 is a first overlap region SR where an electrostatic field is produced. This is the same also with the other embodiments described below.

In FIG. 6, meanwhile, the deflection positive electrode 203 can be moved rightward (toward the printed object) along a direction of jetting-out of ink droplets by loosening the position adjustment screw 205, position adjustment screw 206, and position adjustment screw 207 to move the slide panel 204 rightward and in the drawing, the slide panel 204 is located in the rightmost position. When font size is small, printing can be performed in this state.

A deflection start point 213 that is a position of production of an electrostatic field is a position where a portion of overlapping between the deflection negative electrode 107 and the deflection positive electrode 203 starts on the ink nozzle 103 (Refer to FIG. 2) side. A deflection end point 214 is a position where a portion of overlapping between the deflection negative electrode 107 and the deflection positive electrode 203 ends on the printed object 100 side. Therefore, the area between the deflection start point 213 and the deflection end point 214 is a second overlap region SR where an electrostatic field is produced.

Therefore, when the deflection positive electrode 203 is disposed as shown in FIG. 6, it turns out that the deflection start point 213 has been moved to the printed object 100 side. In addition, the length of the second overlap region SR is shorter than the length of the first overlap region SR as viewed in a direction of jetting-out of ink droplets.

As shown in FIG. 5 and FIG. 6, use of three position adjustment screws enables the deflection positive electrode 203 and the deflection negative electrode 107 to be manually moved by an operator in correspondence with a font size set at the display 2 with parallelism maintained between the electrodes. However, a fixing method need not be limited to position adjustment screws.

The deflection positive electrode 203 can be simply moved by manually operating the position adjustment screws of the slide panel 204. Instead, a disposed position of the deflection positive electrode 203 can also be electrically controlled using a motor, for example, in correspondence with a font size set at the display 2.

A description will be given to a reason why occurrence of scattering is prevented even in printing different in font size by using the deflection electrodes shown in FIG. 5 and FIG. 6.

First, a description will be given to a positional relation between the deflection positive electrode 203 and the deflection negative electrode 107 taken when a character large in font size is printed. When font size is large, the flight paths of ink droplets forming printed dots (for example, the first line and the second line) in the first row adjoining to each other in a line direction in such a print matrix as shown in FIG. 3, for example, are sufficiently away from each other. Therefore, scattering can less probably occur in flying ink droplets. For this reason, positions of the deflection positive electrode 203 and the deflection negative electrode 107 are determined based on the positional relation in FIG. 5.

A description will be given to a positional relation between the deflection positive electrode 203 and the deflection negative electrode 107 taken when a character small in font size is printed. When font size is small, the flight paths of ink droplets forming printed dots (for example, the first line and the second line) adjoining to each other in a line direction in such a print matrix as shown in FIG. 3, for example, are close to each other. Therefore, scattering can occur in flying ink droplets. For this reason, positions of the deflection positive electrode 203 and the deflection negative electrode 107 are determined based on the positional relation in FIG. 6.

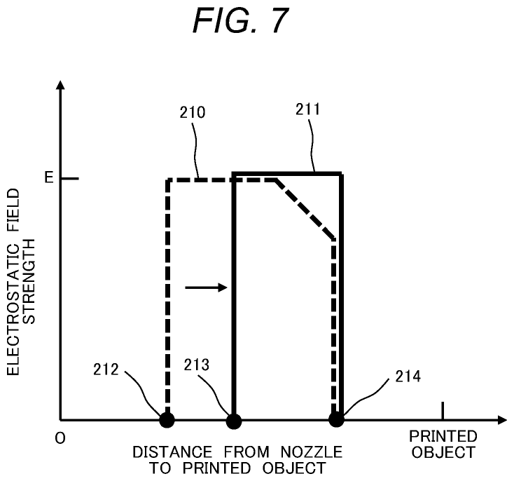

A description will be given to characteristics of an electrostatic field produced by altering a position of the deflection positive electrode 203 according to the above-mentioned font size with reference to FIG. 7.

FIG. 7 illustrates a state of production of an electrostatic field formed by deflection electrodes, caused by a difference in positional relation between the deflection electrodes shown in FIG. 5 and FIG. 6. In FIG. 7, the vertical axis of the graph indicates strength of an electrostatic field produced by the deflection electrodes and the horizontal axis indicates a distance to a printed object when a position of the ink nozzle is taken as a point of origin.

The broken line 210 shown in the graph in FIG. 7 indicates the characteristics of electrostatic field strength obtained when the deflection positive electrode 203 and deflection negative electrode 107 adopting the positional relation in FIG. 5 (when font size is large) are used. An electrostatic field is produced between the deflection start point 212 and the deflection end point 214 in FIG. 5. Meanwhile, the solid line 211 indicates the characteristics of electrostatic field strength obtained when the deflection positive electrode 203 and the deflection negative electrode 107 adopting the positional relation in FIG. 6 (when font size is small) are used. An electrostatic field is produced between the deflection start point 213 and the deflection end point 214 in FIG. 6.

When a character large in font size is printed, scattering can less possibly occur but flying ink droplet need be deflected hard between the ink nozzle 103 and the printed object 100. Therefore, printing is performed in the relation of disposition of deflection electrodes shown in FIG. 5 providing the characteristics indicated by the broken line 210. With the characteristics, a ratio at which an electrostatic field produced by the deflection positive electrode 203 and the deflection negative electrode 107 occupies a distance from the ink nozzle 103 to the printed object 100 is maximized (In this case, the electrostatic field is produced in the region between the deflection start point 212 and the deflection end point 214).

Meanwhile, when a character small in font size is printed, scattering can highly possibly occur but flying ink droplets need not be deflected hard between the ink nozzle 103 and the printed object 100. Therefore, printing is performed in the relation of disposition of deflection electrodes shown in FIG. 6 providing the characteristics indicated by the solid line 210. With the characteristics, a ratio at which an electrostatic field produced by the deflection positive electrode 203 and the deflection negative electrode 107 occupies a distance from the ink nozzle 103 to the printed object 100 is minimized (In this case, the electrostatic field is produced in the region between the deflection start point 213 and the deflection end point 214).

As mentioned above, when printing is performed in the relation of disposition of the deflection positive electrode 203 and the deflection negative electrode 107 shown in FIG. 5, a deflection start point at which ink droplets start deflection is the deflection start point 212. Meanwhile, when printing is performed in the relation of disposition of the deflection positive electrode 203 and the deflection negative electrode 107 shown in FIG. 6, a deflection start point at which ink droplets start deflection is shifted to the deflection start point 213 toward the printed object 100 as indicated by the arrow. The deflection end point 214 is identical.

That is, in the relation of disposition of the deflection positive electrode 203 and the deflection negative electrode 107 shown in FIG. 6, timing with which ink droplets start approaching each other is delayed as compared with the relation of disposition of the deflection positive electrode 203 and the deflection negative electrode 107 shown in FIG. 5. Consequently, ink droplets can be caused to adhere to the printed object before scattering occurs. For this reason, even when a character small in font size is printed, occurrence of displacement of the positions of adherence of ink droplets can be suppressed.

In the description of the present embodiment, a case where the deflection positive electrode 203 is brought closer to the ink nozzle 103 and a case where the electrode is brought closer to the printed object 100 have been taken as examples. The present invention is not limited to this and the electrodes can be disposed in any position as required.

The present embodiment is so configured that the deflection positive electrode 203 is moved to the printed object side. For this reason, the moved deflection positive electrode 203 approaches the gutter 108 and the like in the print head; therefore, taking a measure against electrostatic discharge is effective to prevent electrostatic discharge.

### Example 2

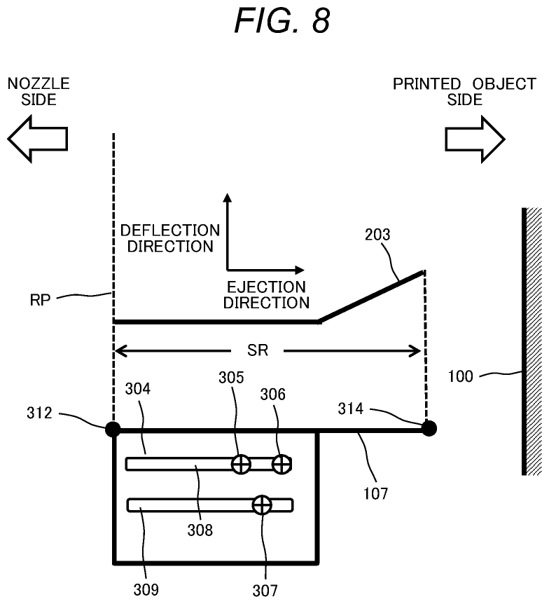

A description will be given to a second embodiment of the present invention with reference to FIG. 8 to FIG. 10. While in the first embodiment, the deflection positive electrode 203 is moved, the present embodiment is so configured that the deflection negative electrode 107 is moved.

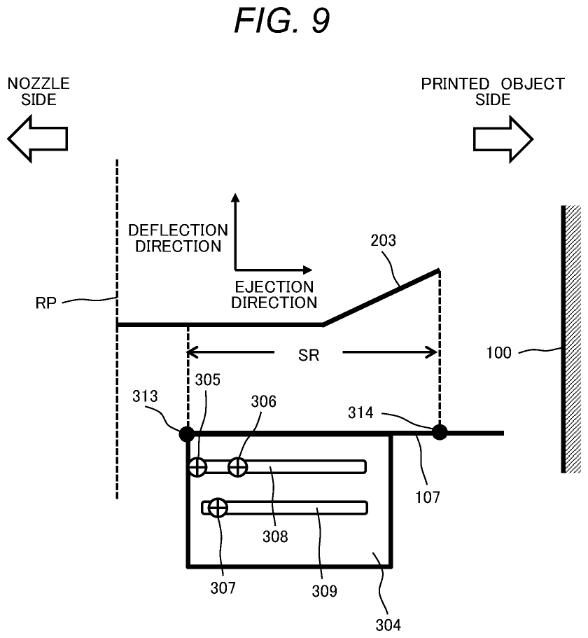

FIG. 8 and FIG. 9 illustrate the embodiment so configured that the deflection negative electrode is movable along a direction of jetting-out of ink droplets. FIG. 8 shows a position of the deflection negative electrode taken when font size is large and FIG. 9 shows a position of the deflection negative electrode taken when font size is small.

In FIG. 8, the position of the deflection positive electrode 203 is fixed and invariant but the deflection negative electrode 107 is movable in a direction of jetting-out of ink droplets. For this reason, the print head is movably equipped with a plate slide panel 304. The deflection negative electrode 107 is fixed at the upper end of the slide panel 304 and the slide panel 304 and the deflection negative electrode 107 are so configured as to be moved together.

The directions of movement of the slide panel 304 and the deflection negative electrode 107 are a direction of jetting-out of ink droplets. This direction of jetting-out of ink droplets is not a direction of deflection of ink droplets but is a direction in which ink droplets straightly travel.

A position adjustment groove 308 and a position adjustment groove 309 are formed in the slide panel 304 and a position adjustment screw 305, a position adjustment screw 306, and a position adjustment screw 307 are inserted into the position adjustment groove 308 and the position adjustment groove 309 and screwed into the inner wall of the print head. As a result, the slide panel 304 is fixed on the inner wall of the print head by moving the slide panel 304 and adjusting the position thereof relative to the print head and then tightening the position adjustment screw 305, position adjustment screw 306, and position adjustment screw 307.

As mentioned above, the slide panel 304 and the deflection negative electrode 107 can be moved in a direction of jetting-out of ink droplets through the position adjustment groove 308 and the position adjustment groove 309 by loosening the position adjustment screw 305, position adjustment screw 306, and position adjustment screw 307.

FIG. 8 illustrates the deflection negative electrode 107 and the deflection positive electrode 203 as are located in a reference position RP and in the drawing, the slide panel 304 is located in the leftmost position. When font size is large, printing can be performed in this state.

A deflection start point 312 that is a position of production of an electrostatic field is a position where a portion of overlapping between the deflection negative electrode 107 and the deflection positive electrode 203 starts on the ink nozzle 103 (Refer to FIG. 2) side. A deflection end point 314 that is a position of annihilation of an electrostatic field is a position where a portion of overlapping between the deflection negative electrode 107 and the deflection positive electrode 203 ends on the printed object 100 side. Therefore, the area between the deflection start point 312 and the deflection end point 314 is a first overlap region SR where an electrostatic field is produced.

In FIG. 9, meanwhile, the deflection negative electrode 107 can be moved rightward (toward the printed object) along a direction of jetting-out of ink droplets by loosening the position adjustment screw 305, position adjustment screw 306, and position adjustment screw 307 to move the slide panel 304 rightward and in the drawing, the slide panel 304 is located in the rightmost position. When font size is small, printing can be performed in this state.

A deflection start point 313 that is a position of production of an electrostatic field is a position where a portion of overlapping between the deflection negative electrode 107 and the deflection positive electrode 203 starts on the ink nozzle 103 (Refer to FIG. 2) side. A deflection end point 314 is a position where a portion of overlapping between the deflection negative electrode 107 and the deflection positive electrode 203 ends on the printed object 100 side. Therefore, the area between the deflection start point 313 and the deflection end point 314 is a second overlap region SR where an electrostatic field is produced.

Therefore, when the deflection negative electrode 107 is disposed as shown in FIG. 9, it turns out that the deflection start point 313 has been moved to the printed object 100 side. In addition, the length of the second overlap region SR is shorter than the length of the first overlap region SR as viewed in a direction of jetting-out of ink droplet.

As shown in FIG. 8 and FIG. 9, use of three position adjustment screws enables the deflection positive electrode 203 and the deflection negative electrode 107 to be manually moved by an operator in accordance with a font size set at the display 2 with parallelism maintained between the electrodes. However, the fixing method need not be limited to the position adjustment screws.

The deflection negative electrode 107 can be simply moved by manually operating the position adjustment screws of the slide panel 304. Instead, a disposed position of the deflection negative electrode 107 can also be electrically controlled using a motor, for example, in correspondence with a font size set at the display 2.

A description will be given to a reason why occurrence of scattering is prevented even in printing different in font size by using the deflection electrodes shown in FIG. 8 and FIG. 9.

First, a description will be given to a positional relation between the deflection positive electrode 203 and the deflection negative electrode 107 taken when a character large in font size is printed. When font size is large, the flight paths of ink droplets forming printed dots (for example, the first line and the second line) in the first row adjoining to each other in a line direction in such a print matrix as shown in FIG. 3 are sufficiently away from each other. Therefore, scattering can less probably occur in flying ink droplets. For this reason, positions of the deflection positive electrode 203 and the deflection negative electrode 107 are determined based on the positional relation in FIG. 5.

A description will be given to a positional relation between the deflection positive electrode 203 and the deflection negative electrode 107 taken when a character small in font size is printed. When font size is small, the flight paths of ink droplets forming printed dots (for example, the first line and the second line) adjoining to each other in a line direction in such a print matrix as shown in FIG. 3, for example, are close to each other. Therefore, scattering can occur in flying ink droplets. For this reason, positions of the deflection positive electrode 203 and the deflection negative electrode 107 are determined based on the positional relation in FIG. 9.

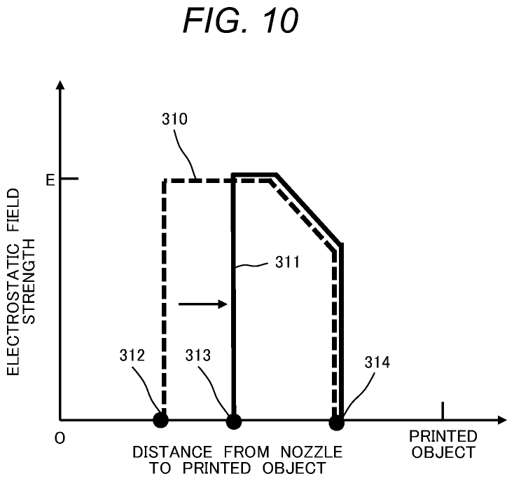

A description will be given to characteristics of an electrostatic field produced by altering a position of the deflection negative electrode 107 according to the above-mentioned font size with reference to FIG. 10.

FIG. 10 illustrates a state of production of an electrostatic field formed by deflection electrodes, caused by a difference in positional relation between the deflection electrodes shown in FIG. 8 and FIG. 9. In FIG. 10, the vertical axis of the graph indicates strength of an electrostatic field produced by the deflection electrodes and the horizontal axis indicates a distance to a printed object when a position of the ink nozzle is taken as a point of origin.

The broken line 310 shown in the graph in FIG. 10 indicates the characteristics of electrostatic field strength obtained when the deflection positive electrode 203 and the deflection negative electrode 107 adopting the positional relation in FIG. 8 are used. An electrostatic field is produced between the deflection start point 312 and the deflection end point 314 in FIG. 8. Meanwhile, the solid line 311 indicates the characteristics of electrostatic field strength obtained when the deflection positive electrode 203 and the deflection negative electrode 107 adopting the positional relation in FIG. 9 are used. An electrostatic field is produced between the deflection start point 313 and the deflection end point 314 in FIG. 9.

When a character large in font size is printed, scattering can less possibly occur but flying ink droplet need be deflected hard between the ink nozzle 103 and the printed object 100. Therefore, printing is performed in the relation of disposition of deflection electrodes shown in FIG. 8 providing the characteristics indicated by the broken line 310. With the characteristics, a ratio at which an electrostatic field produced by the deflection positive electrode 203 and the deflection negative electrode 107 occupies a distance from the ink nozzle 103 to the printed object 100 is maximized (In this case, the electrostatic field is produced in the region between the deflection start point 312 and the deflection end point 314).

Meanwhile, when a character small in font size is printed, scattering can highly possibly occur but flying ink droplets need not be deflected hard between the ink nozzle 103 and the printed object 100. Therefore, printing is performed in the relation of disposition of deflection electrodes shown in FIG. 9 providing the characteristics indicated by the solid line 210. With the characteristics, a ratio at which an electrostatic field produced by the deflection positive electrode 203 and the deflection negative electrode 107 occupies a distance from the ink nozzle 103 to the printed object 100 is minimized (In this case, the electrostatic field is produced in the region between the deflection start point 313 and the deflection end point 314).

As mentioned above, when printing is performed in the relation of disposition of the deflection positive electrode 203 and the deflection negative electrode 107 shown in FIG. 8, a deflection start point at which ink droplets start deflection is the deflection start point 312. Meanwhile, when printing is performed in the relation of disposition of the deflection positive electrode 203 and the deflection negative electrode 107 shown in FIG. 9, a deflection start point at which ink droplets start deflection is shifted to the deflection start point 313 toward the printed object 100 as indicated by the arrow. The deflection end point 314 is identical.

That is, in the relation of disposition of the deflection positive electrode 203 and the deflection negative electrode 107 shown in FIG. 9, timing with which ink droplets start approaching each other is delayed as compared with the relation of disposition of the deflection positive electrode 203 and the deflection negative electrode 107 shown in FIG. 8. Consequently, ink droplets can be caused to adhere to the printed object before scattering occurs. For this reason, even when a character small in font size is printed, occurrence of displacement of the positions of adherence of ink droplets can be suppressed.

In the description of the present embodiment, a case where the deflection negative electrode 107 is brought closer to the ink nozzle 103 and a case where the electrode is brought closer to the printed object 100 have been taken as examples. The present invention is not limited to this and the electrodes can be disposed in any position as required.

Unlike the first embodiment, the present embodiment is so configured that the deflection negative electrode is moved. For this reason, the following advantage is brought about: Consideration need not be given to occurrence of electrostatic discharge between the deflection positive electrode and the gutter 108 (Refer to FIG. 2) in the print head due to movement of the deflection positive electrode. Meanwhile, when the deflection negative electrode 107 is moved, taking a measure against interference with the gutter 108 (Refer to FIG. 2) is also effective to prevent interference.

### Example 3

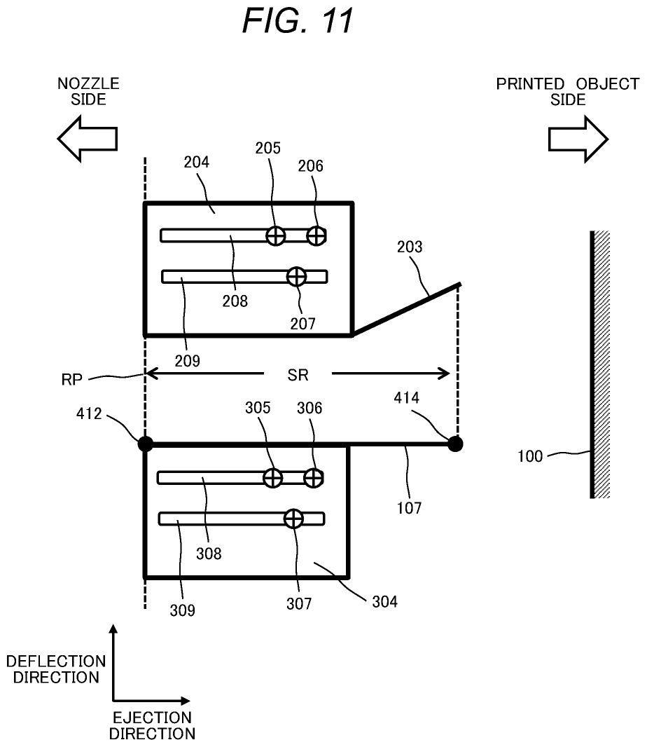

A description will be given to a third embodiment of the present invention with reference to FIG. 11 to FIG. 13. In the first embodiment, the deflection positive electrode 203 is moved and in the second embodiment, the deflection negative electrode 107 is moved. The present embodiment is so configured that both the deflection positive electrode 203 and the deflection negative electrode 107 are moved. As a result, the present embodiment can be made different from the first embodiment and the second embodiment in the characteristics of an electrostatic field produced by the deflection positive electrode 203 and the deflection negative electrode 107. That is, while in the first embodiment and the second embodiment, the characteristics of an electrostatic field differ, in the present embodiment, the electrodes can be moved without altering the characteristics of an electrostatic field.

A configuration in which the deflection positive electrode 203 is moved has been described in relation to the first embodiment and a configuration in which the deflection negative electrode 107 is moved has been described in relation to the second embodiment. Since the present embodiment is configured of a combination of these configurations and a configuration of the present embodiment overlaps with these configurations, a description of the present embodiment will be omitted. An identical component will be marked with an identical reference numeral.

FIG. 11 illustrates a case where a print in which a spacing between adjoining printed dots is long is made with a character large in font size. The drawing shows a relation of disposition of the deflection positive electrode 203 and the deflection negative electrode 107 taken when a number of printed dots in a line direction in a row direction is small. In this case, the flight paths of ink droplets forming printed dots adjoining to each other in a line direction of the print matrix are sufficiently away from each other and scattering can less probably occur in ink droplets in flight. Therefore, printing is performed with the deflection positive electrode 203 and the deflection negative electrode 107 disposed as shown in FIG. 11.

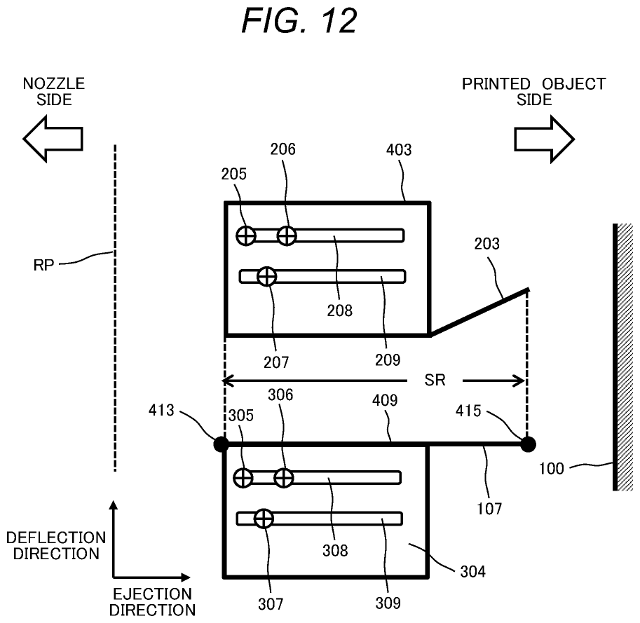

Meanwhile, when a character large in font size is printed but a number of printed dots in a line direction in a row direction of the print matrix is large and a spacing between adjoining printed dots is short, the flight paths of ink droplets forming printed dots are close to each other. Therefore, printing is performed with the deflection positive electrode 203 and the deflection negative electrode 107 disposed as shown in FIG. 12.

In comparison with the first embodiment and the second embodiment, the present embodiment is suitable for printing in which a large character is printed but a number of printed dots in a line direction in a row direction of the print matrix is large and the flight paths of ink droplets are prone to be brought close to each other.

A description will be given to a reason why positions of disposition of the deflection positive electrode 203 and the deflection negative electrode 107 are adjusted.

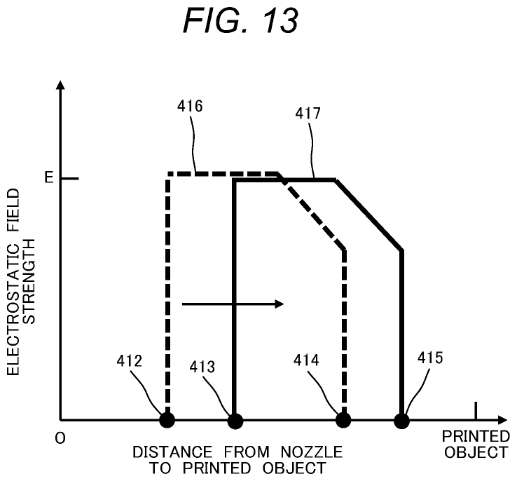

FIG. 13 illustrates the characteristics of an electrostatic field produced by the deflection positive electrode 203 and the deflection negative electrode 107 disposed as shown in FIG. 11 and FIG. 12. In FIG. 13, the vertical axis of the graph indicates strength of an electrostatic field produced by the deflection electrodes and the horizontal axis indicates a distance to a printed object when a position of the ink nozzle is taken as a point of origin.

The broken line 416 shown in the graph in FIG. 13 indicates the characteristics of electrostatic field strength obtained when the deflection positive electrode 203 and the deflection negative electrode 107 adopting the positional relation in FIG. 11 are used. An electrostatic field is produced between a deflection start point 412 that is the position of production of an electrostatic field in FIG. 12 and a deflection end point 414 that is the position of annihilation of an electrostatic field.

Meanwhile, the solid line 417 indicates the characteristics of electrostatic field strength obtained when the deflection positive electrode 203 and the deflection negative electrode 107 adopting the positional relation in FIG. 12 are used. An electrostatic field is produced between a deflection start point 413 that is the position of production of an electrostatic field in FIG. 13 and a deflection end point 415 that is the position of annihilation of an electrostatic field. The characteristics of an electrostatic field indicated by the broken line 416 and the characteristics of an electrostatic field indicated by the solid line 417 are identical with each other but are different from each other in a distance to the printed object.

When a character large in font size and further wide in a spacing between printed dots in a line direction in a row direction is printed, scattering can less probably occur but flying ink droplets need be deflected hard between the ink nozzle 103 (Refer to FIG. 2) and the printed object 100. Therefore, printing is performed in the relation of disposition of deflection electrodes shown in FIG. 11 providing the characteristics indicated by the broken line 416. With the characteristics, a ratio at which an electrostatic field produced by the deflection positive electrode 203 and the deflection negative electrode 107 occupies a distance from the ink nozzle 103 to the printed object 100 is maximized (In this case, the electrostatic field is produced in the region between the deflection start point 412 and the deflection end point 414).

Meanwhile, when a character large in font size and further narrow in a spacing between printed dots in a line direction in a row direction is printed, ink droplets approach each other during flight and scattering can occur. Further, flying ink droplets need be deflected hard between the ink nozzle 103 and the printed object 100.

Therefore, printing is performed in the relation of disposition of deflection electrodes shown in FIG. 12 providing the characteristics indicated by the solid line 417. With the characteristics, a ratio at which an electrostatic field produced by the deflection positive electrode 203 and the deflection negative electrode 107 occupies a distance from the ink nozzle 103 to the printed object 100 is maximized (In this case, the electrostatic field is produced in the region between the deflection start point 413 and the deflection end point 415).

As mentioned above, when printing is performed in the relation of disposition of the deflection positive electrode 203 and the deflection negative electrode 107 shown in FIG. 11, a deflection start point at which ink droplets start deflection is the deflection start point 412. Meanwhile, when printing is performed in the relation of disposition of the deflection positive electrode 203 and the deflection negative electrode 107 shown in FIG. 12, a deflection start point at which ink droplets start deflection is the deflection start point 413. The deflection end point 414 is translated to the deflection end point 415.

That is, in the relation of disposition of the deflection positive electrode 203 and the deflection negative electrode 107 shown in FIG. 12, timing with which ink droplets start approaching each other is delayed as compared with the relation of disposition of the deflection positive electrode 203 and the deflection negative electrode 107 shown in FIG. 11. Consequently, ink droplets can be caused to adhere to the printed object before scattering occurs. For this reason, even when a character large in font size and further narrow in a spacing between printed dots in a line direction in a row direction is printed, occurrence of displacement of the position of adherence of ink droplets can be suppressed.

In the description of the present embodiment, a case where the deflection positive electrode 203 and the deflection negative electrode 107 are brought closer to the ink nozzle 103 and a case where the electrodes are brought closer to the printed object 100 have been taken as examples. The present invention is not limited to this and the electrodes can be disposed in any position as required.

In the present embodiment, both the deflection positive electrode 203 and the deflection negative electrode 107 are moved. For this reason, the moved deflection positive electrode 203 approaches the gutter 108 and the like in the print head; therefore, taking a measure against electrostatic discharge is effective to prevent electrostatic discharge. When the deflection negative electrode 107 is moved, taking a measure against interference with the gutter 108 (Refer to FIG. 2) is also effective to prevent interference.

The present invention is not limited to the above-mentioned embodiments and includes various modifications. For example, the above-mentioned embodiments have been described in detail to make the present invention easier to understand and the present invention is not necessarily limited to those provided with all the configurations described above. Some of the configuration elements of some embodiment can be replaced with a configuration element of another embodiment and a configuration element of some embodiment can also be added to the configuration elements of another embodiment. Some configuration element of each embodiment can be added to, deleted from, or replaced with another configuration element.

### REFERENCE SIGNS LIST

1: inkjet recording device main body, 2: display, 3: cable, 4: print head, 100: printed object, 103: ink nozzle, 105: electrifying electrode, 106: deflection positive electrode, 107: deflection negative electrode, 111: electrified ink droplet, 112: non-electrified ink droplet, 203: deflection positive electrode, 204, 304: slide panel

1. An inkjet recording device provided with a print head including:
an ink nozzle jetting out ink liquid as ink droplets;
an electrifying electrode electrifying the ink droplets;
a deflection positive electrode and a deflection negative electrode that deflect the electrified ink droplets; and
a gutter collecting the ink droplets not used for printing,
wherein a position of production of an electrostatic field formed by the deflection positive electrode and the deflection negative electrode can be adjusted in a direction of jetting-out of the ink droplets.

2. The inkjet recording device according to claim 1,
wherein a position of production of the electrostatic field is adjusted by movement of the deflection positive electrode.

3. The inkjet recording device according to claim 2,
wherein movement of the deflection positive electrode is performed manually or by electrical control.

4. The inkjet recording device according to claim 1,
wherein a position of production of the electrostatic field is adjusted by movement of the deflection negative electrode.

5. The inkjet recording device according to claim 4,
wherein movement of the deflection negative electrode is performed manually or by electrical control.

6. The inkjet recording device according to claim 1,
wherein a position of production of the electrostatic field is adjusted by movement of both the deflection positive electrode and the deflection negative electrode.

7. The inkjet recording device according to claim 6,
wherein movement of the deflection positive electrode and the deflection negative electrode is performed manually or by electrical control.

8. An inkjet recording device provided with a print head including:
an ink nozzle jetting out ink liquid as ink droplets;
an electrifying electrode electrifying the ink droplets;
a deflection positive electrode and a deflection negative electrode that deflect the electrified ink droplets; and
a gutter collecting the ink droplets not used for printing,
wherein when a character large in font size is printed, adjustment is so made that a position of production of an electrostatic field formed by the deflection positive electrode and the deflection negative electrode is brought closer to the ink nozzle, and
wherein when a character small in font size is printed, adjustment is so made that a position of production of an electrostatic field formed by the deflection positive electrode and the deflection negative electrode is brought closer to a printed object as compared with when a character large in font size is printed.

9. The inkjet recording device according to claim 8,
wherein when a character large in font size is printed, the deflection positive electrode and the deflection negative electrode are disposed closer to the ink nozzle, and
wherein when a character small in font size is printed, the deflection positive electrode is disposed closer to the printed object.

10. The inkjet recording device according to claim 8,
wherein when a character large in font size is printed, the deflection positive electrode and the deflection negative electrode are disposed closer to the ink nozzle, and
wherein when a character small in font size is printed, the deflection negative electrode is disposed closer to the printed object.

11. The inkjet recording device according to claim 8,
wherein as compared with the length of a first overlap region, as viewed in a direction of jetting-out of the ink droplets, where when a character large in font size is printed, the deflection positive electrode and the deflection negative electrode overlap with each other, the length of a second overlap region, as viewed in a direction of jetting-out of the ink droplets, where when a character small in font size is printed, the deflection positive electrode and the deflection negative electrode overlap with each other is shorter.
